(19) United States
(12) Patent Application Publication
(10) Pub. No.: US 2004/0222956 A1
(43) Pub. Date: Nov. 11, 2004

(54) Method for overdriving a liquid crystal display and defining gradation voltages therefor

(76) Inventor: Po Sheng Shih, Tao-Yuan Hsien (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/807,385

(22) Filed: Mar. 24, 2004

(30) Foreign Application Priority Data
May 11, 2003 (CN) 092130915

(51) Int. Cl. G09G 3/36

(52) U.S. Cl. 345/89

(57) ABSTRACT

A method is for overdriving a liquid crystal display (LCD) and defining gradation voltages therefor. The gradation voltages are defined by a dynamic light transmittance vs. voltage curve. Within a vertical scanning period, a working voltage and a black voltage are sequentially applied to a plurality of pixels on a LCD. The product of the applied time and the brightness curve resulting from the working voltage is divided by the duration of the vertical scanning period and an effective brightness is obtained from the product operation. Moreover, the effective brightness is transferred into an effective light transmittance. We repeat the aforesaid steps to obtain a light transmittance vs. voltage curve, and define a plurality of gray levels and their corresponding gradation voltages according to the light transmittance vs. voltage curve. The gradation voltages are relatively higher than those defined by a steady light transmittance vs. voltage curve; and consequently, they can accelerate the response time of the LCD.

### BACKGROUND OF THE INVENTION

1. Field of the Invention

The present invention relates to a method for overdriving a liquid crystal display (LCD) and defining gradation voltages therefor, relates to an overdriving method that defines gradation voltages by a dynamic light transmittance vs. driving voltage curve.

2. Description of the Related Art

The manufacturing technique for LCDs has improved in the field of flat-panel displays with high contrast and a wide angle of view. However, for dynamic images displaying continuous movement, the image quality deteriorates due to a residual image phenomenon. Recently, there have been many driving methods for improving the image quality of LCDs, and the black data insertion method provided by the NEC Corporation is one suitable solution for the dynamic image issue. The prior art applies the voltage of a black datum in a sequence to the liquid crystal (LC) capacitor of each pixel during a frame period so as to have an “impulse-type” effect on the same display as a cathode ray tube (CRT) does. Therefore, a user can see sharp and clear images displaying a continuously moving object at every instant and every angle.

FIG. 1 is the optical response waveform diagram of a conventional LCD. The data signal 11 within each vertical scanning period includes two potentials, a gradation voltage 111, and a black voltage 112, wherein the black voltage 112 makes a pixel change to black from a predetermined color in response to the gradation voltage 111. A waveform 13 represents the delayed optical response of an LCD, and illustrates that the light transmittance ratio changes to zero due to the writing of the black voltage 112 before it reaches the predetermined value in terms of the gradation voltage 111. If the function of black data insertion is removed from the LCD, i.e., only the potential regarding the gradation voltage 111 remains in the data signal 11, then the optical response of the LCD is reshaped as the waveform 12 shown. The light transmittance ratio corresponding to the peak of the waveform 12 is designated as the default value in response to the gradation voltage 111.

The waveform 15 shown in FIG. 1 represents the speeded optical response of an LCD. Ordinary overdriving methods disclose that the rapid optical response can be achieved by means of accelerating the rotation speed of the liquid crystal molecules. Among those methods, the dynamic capacitance compensation (DCC) method proposed by the Korean Samsung Electronics is a practical overdriving method. The prior art discloses that the difference of the gradation voltages for the pixels between a proceeding frame and a succeeding frame needs to be calculated, and appropriate compensation voltages are given according to the difference in value. In this way, the optical response of the pixels is accelerated. However, the prior art cannot be applied to the LCD together with the driving method of black data insertion, because if a black voltage 112, which makes the pixel turn black, is applied to each of the pixels between two adjacent frames, the compensation voltages, which is still determined by the gradation difference between the two frames, certainly causes the pixels not to display adequate gray levels during the next frame.

Usually, the gradation voltage corresponding to the light transmittance is obtained by a steady transmittance vs. voltage (T-V) curve, as shown in FIG. 2. If a voltage is applied to the two terminals of the liquid crystal capacitor of a pixel, the liquid crystal molecules in the liquid crystal capacitor are rotated to a predetermined angular posture due to the change of the electric field, and meanwhile the light transmittance measured for the pixel is designated as a steady light transmittance after the posture of crystal liquid molecules remain steady. Referring to FIG. 2, T_{L0}-T_{L255} are the light transmittances corresponding to each gray level of a eight-bits data signal (L0-L255 have 256 levels in all), and the corresponding gradation voltages V_{L0}-V_{L255} for driving the liquid crystal capacitor can be obtained respectively according to the T-V curve.

However, the brightness felt by human retinas is not a constant value in a steady state, but it is the effect based on the product of the variable brightness and the sensing time. Usually, the brightness of the LCD is obtained by the light transmittance multiplied by the brightness of a backlight source having a constant brightness in general. Therefore, even if the prior art has taught us to accelerate the response speed of the liquid crystal capacitor, it still cannot satisfy the time factor of the brightness felt by the viewer's vision because of the existence of the delay phenomenon in the optical response.

### SUMMARY OF THE INVENTION

The objective of the present invention is to provide a method for overdriving a liquid crystal display and defining gradation voltages therefor. The method discloses that a dynamic light transmittance vs. voltage curve is derived from the product of variable brightness and time. The gradation voltage corresponding to each gray level can also be defined by means of the dynamic relation curve, therefore it can satisfy the time factor of the brightness felt by the viewer's vision because of the existence of the delay phenomenon in the optical response.

In order to achieve the objective, the presented invention discloses a method for overdriving the liquid crystal display (LCD) and defining gradation voltages therefor. The gradation voltages are defined by a dynamic light transmittance vs. voltage curve. Within a vertical scanning period, sequentially a working voltage and a black voltage are applied to a plurality of pixels on a LCD. And the product of the applied time and the brightness curve resulting from the working voltage is divided by the duration of the vertical scanning period and an effective brightness is obtained from the product operation. Moreover, the effective brightness is transferred into an effective light transmittance. We repeat the aforesaid steps to obtain a light transmittance vs. voltage curve, and define a plurality of gray levels and their corresponding gradation voltages according to the light transmittance vs. voltage curve. The gradation voltages are relatively higher than those defined by a steady light transmittance vs. voltage curve; consequently, they can accelerate the response time of the LCD.

### BRIEF DESCRIPTION OF THE DRAWINGS

The invention will be described according to the appended drawings in which:

FIG. 1 is an optical response waveform diagram of a conventional LCD;

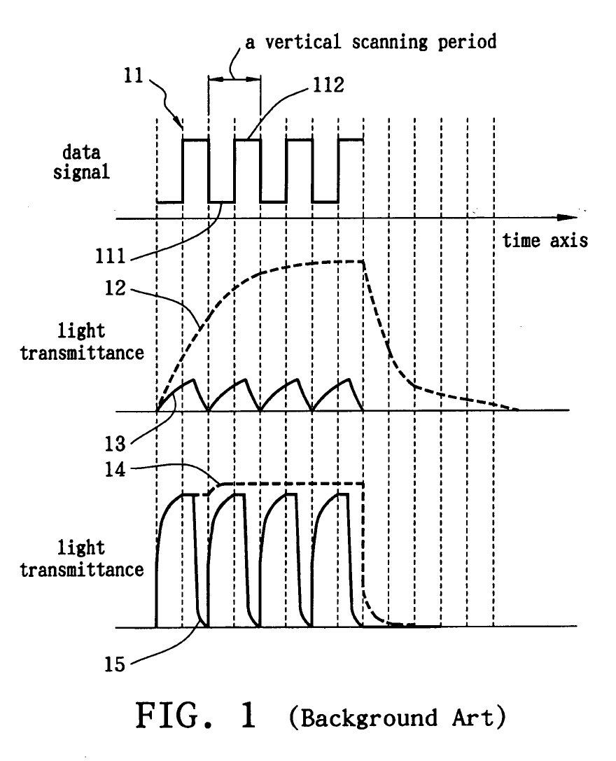

FIG. 2 is a graph of a conventional light transmittance vs. voltage curve;

FIG. 3 is a graph of a brightness curve in accordance with the present invention;

FIG. 4 is a graph of a light transmittance vs. voltage curve in accordance with the present invention; and

FIG. 5 is a graph of an effective brightness vs. voltage curve in accordance with the present invention

### PREFERRED EMBODIMENT OF THE PRESENT INVENTION

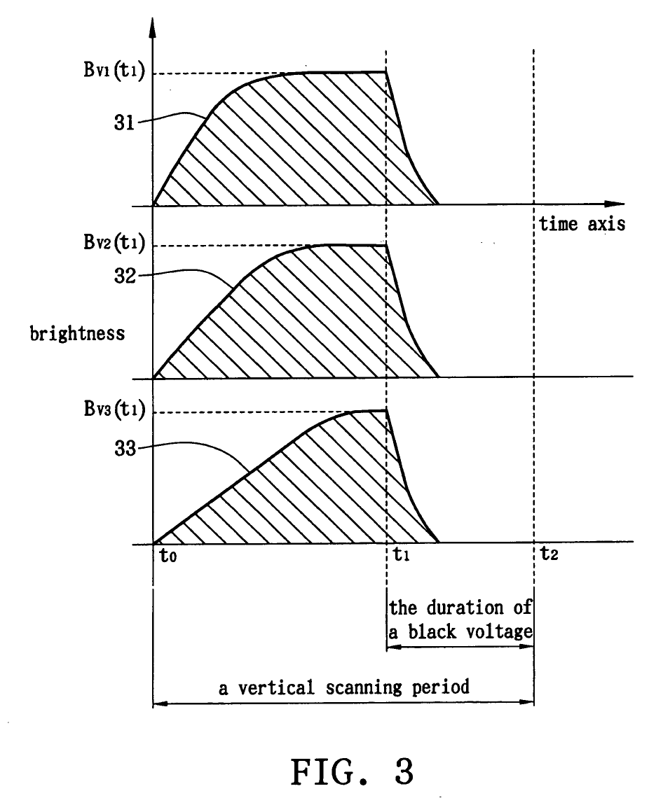

In order to speed up the optical response of an LCD, the present invention provides an overdriving method for the LCD, i.e., it achieves the acceleration and brightening effects by increasing the driving voltage. FIG. 3 is an illustrative graph of a brightness curve in accordance with the present invention. Curves 31, 32 and 33 respectively represents the variations of brightness along a time axis and are obtained from respectively applying working voltages V₁, V₂ and V₃ to the two terminals of the liquid crystal capacitor of a pixel during a t, interval. The three curves are also expressed by the brightness functions B₁ (t), Bᵥ₂ (t) and Bᵥ₃ (t).

When time is at the ti moment, a black voltage is instantly applied to the pixel for reducing the brightness towards zero. When time is at the t₂ moment, a complete vertical scanning period ends. We integrate the brightness functions Bᵥ₁ (t), Bᵥ₂ (t) and Bᵥ₃ (t) by time within the vertical scanning period to obtain their corresponding brightness accumulation, and the brightness accumulation is divided by the vertical scanning period t₀-t₂ to obtain their corresponding effective brightness respectively as the following formulas express:

$${B}_{V1}^{′} = \frac{1}{{t}_{2} - {t}_{0}} {\int }_{{t}_{0}}^{{t}_{2}} {B}_{V1} ( t ) ⅆ t ;$$

$${B}_{V2}^{′} = \frac{1}{{t}_{2} - {t}_{0}} {\int }_{{t}_{0}}^{{t}_{2}} {B}_{V2} ( t ) ⅆ t ; and$$

$${B}_{V3}^{′} = \frac{1}{{t}_{2} - {t}_{0}} {\int }_{{t}_{0}}^{{t}_{2}} {B}_{V3} ( t ) ⅆ t ;$$

wherein B_{V1}^{′}, B_{V2}^{′} and B_{V3}^{′} are the effective brightness corresponding to the working voltages V₁, V₂ and V₃, respectively.

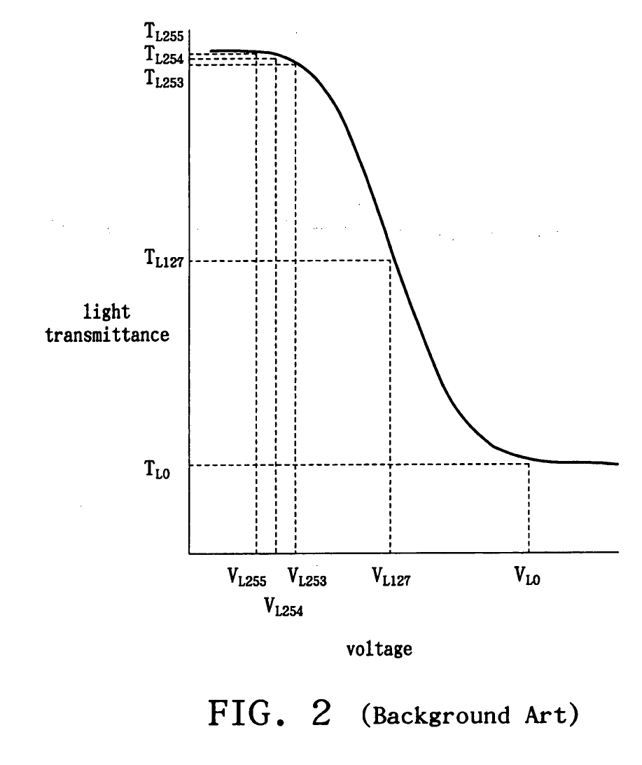

As shown in FIG. 2 and FIG. 3, the steady state value of the brightness curves 31, 32 and 33 are almost equal to each other, that is, B_{V1} (t₁)≈BV2 (t₁)≈B_{V3} (t₁). In other words, after applying working voltages V₁, V₂ and V₃ to the two terminals of the liquid crystal capacitor of a pixel during an interval, respectively, the liquid crystal molecules in the liquid crystal capacitor are rotated to a predetermined angular posture due to the change of the electric field, and meanwhile the light transmittance measured for the pixel is approximately the same for these applied working voltages. But apparently the areas of three shadow portions in this figure are quite different; therefore the effective brightness, B_{V1}^{′}, B_{V2}^{′} and B_{V3}^{′}, corresponding to the working voltages, V₁, V₂ and V₃, are different from each other.

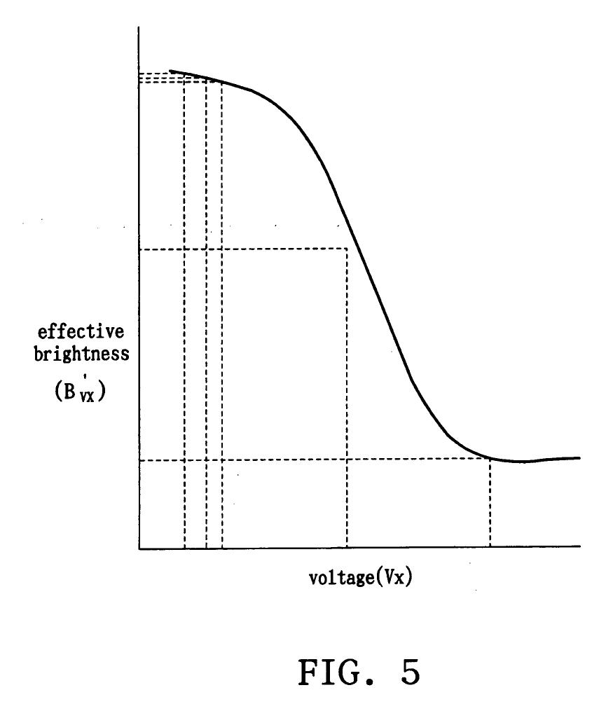

By iterating the aforesaid steps, other applied voltages and their corresponding effective brightness also can be obtained, and meanwhile an effective brightness vs. voltage curve can be depicted from this data, as shown in FIG. 5.

FIG. 5 is a graph of an effective brightness vs. voltage curve in accordance with the present invention. An effective light transmittance T_{VX}^{′} can be derived from the effective brightness B_{VX}^{′} divided by the brightness of a backlight as follows:

$${T}_{VX}^{′} = \frac{{B}_{VX}^{′}}{L} ;$$

wherein V_{X} represents the working voltage corresponding to the effective brightness B_{VX}^{′} and L represents the brightness of the background light source.

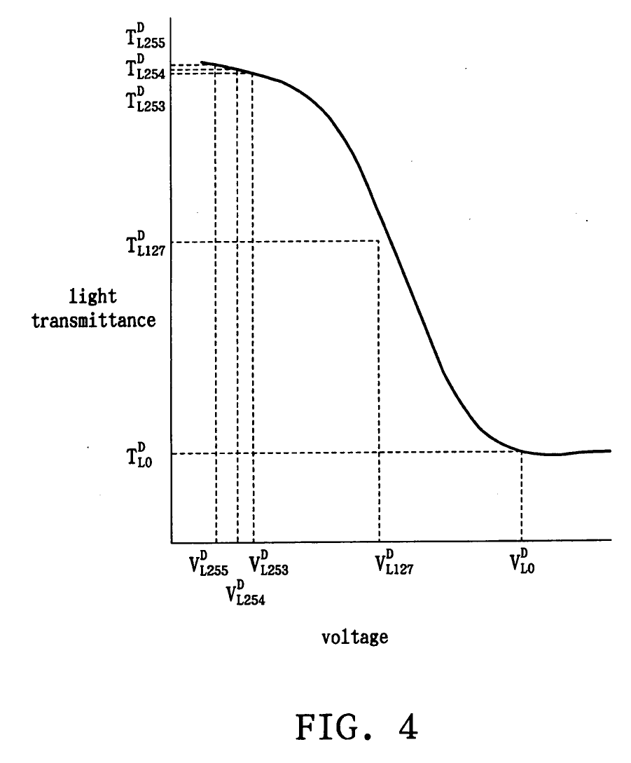

Therefore, the effective brightness vs. voltage curve in FIG. 5 can be transferred into the effective light transmittance vs. voltage curve in FIG. 4. We define the gray levels and its corresponding gradation voltages according to the dynamic light transmittance vs. voltage curve in FIG. 4. Hereinafter, an LCD with eight-bits data signal provided is regarded as the embodiment of the present invention; therefore, the determined gray levels of a pixel totally have 256 levels ranging from L₀ to L₂₅₅. In comparison with the prior art in FIG. 2, gradation voltages V_{1.255}^{D}·V_{1.254}^{D} and VD_{1.253}^{D} are defined by the method of the present invention, and their inequalities are obtained as follows:

V_{1.255}^{D}>V_{1.255};

V_{1.254}^{D}>V_{1.254}; and

V_{1.253}^{D}>V_{1.253}.

That is, the gradation voltages for driving the liquid crystal capacitor are relatively increased so as to accelerate the optical response of the LCD.

Apparently, the dynamic effective brightness vs. voltage curve is derived from the product of the variation of brightness and time, and the objective of the present invention is to meet the time effect of the brightness felt by viewer's vision. On the other hand, the duration of the optical response for the LCD is shortened by the increase of the driving voltage, and meanwhile the brightness displayed by each frame is also raised.

The above-described embodiments of the present invention are intended to be illustrative only. Numerous alternative embodiments may be devised by persons skilled in the art without departing from the scope of the following claims.

What is claimed is:

1. A method for defining gradation voltages of a liquid crystal display (LCD), comprising the steps of:
(a) applying a working voltage and a black voltage sequentially to a plurality of pixels on the liquid crystal display within a vertical scanning period;
(b) integrating a brightness curve resulting from the working voltage with time during the duration of the working voltage to obtain a product, and deriving an effective brightness from the quotient by dividing the product by the duration of the vertical scanning period;
(c) transferring the effective brightness into an effective light transmittance;
(d) iterating the aforesaid steps (a)-(c) to obtain a light transmittance vs. voltage curve; and
(e) defining a plurality of gray levels and gradation voltages corresponding to the plurality of gray levels according to the light transmittance vs. voltage curve.

2. The method for defining gradation voltages of a liquid crystal display of claim 1, wherein the light transmittance vs. voltage curve expresses a dynamic relation between the light transmittance and the gradation voltages.

3. The method for defining gradation voltages of a liquid crystal display of claim 1, further comprising the step of:
dividing the effective brightness by the brightness of a backlight source in the liquid crystal display to obtain the effective light transmittance.

4. The method for defining gradation voltages of a liquid crystal display of claim 1, wherein the liquid crystal display simultaneously employs a black-data-insertion driving method.

5. The method for defining gradation voltages of a liquid crystal display of claim 1, wherein each of the gradation voltages given by step (e) is higher than each of the gradation voltages determined by a steady light transmittance vs. voltage curve for the same gray level so as to accelerate the response speed of the liquid crystal display.

6. A method for overdriving a liquid crystal display, employing gradation voltages defined by a dynamic light transmittance vs. voltage curve, comprising the steps of:
(a) applying a working voltage and a black voltage sequentially to a plurality of pixels on the liquid crystal display within a vertical scanning period;
(b) integrating a brightness curve resulting from the working voltage with time during the duration of the working voltage to obtain a product, and deriving an effective brightness from the quotient by dividing the product by the duration of the vertical scanning period;
(c) transferring the effective brightness into an effective light transmittance;
(d) iterating the aforesaid steps (a)-(c) to obtain a light transmittance vs. voltage curve; and
(e) defining a plurality of gray levels and gradation voltages corresponding to the plurality of gray levels according to the light transmittance vs. voltage curve;
wherein each of the gradation voltages is higher than each of the gradation voltages determined by a steady light transmittance vs. voltage curve for the same gray level so as to accelerate the response speed of the liquid crystal display.

7. The method for overdriving a liquid crystal display of claim 6, wherein the liquid crystal display simultaneously employs a black-data-insertion driving method.

8. The method for overdriving a liquid crystal display of claim 6, further comprising the step of:
dividing the effective brightness by the brightness of a backlight source in the liquid crystal display to obtain the effective light transmittance.
